(19) United States
(12) Patent Application Publication
(10) Pub. No.: US 2025/0034467 A1
(43) Pub. Date: Jan. 30, 2025

(54) METHOD AND DEVICE FOR MAKING HYDROGEN FROM HETEROGENOUS WASTE

(71) Applicant: CLEAN ENERGY ENTERPRISES Inc., LONG BEACH, CA (US)

(72) Inventors: Jean Louis KINDLER, LOS ANGELES, CA (US); William CHARNESKI, SANTA MONICA, CA (US); HARDIK Y DESAI, SURAT (IN)

(73) Assignee: CLEAN ENERGY ENTERPRISES Inc., LONG BEACH, CA (US)

(21) Appl. No.: 18/907,420

(22) Filed: Oct. 4, 2024

Related U.S. Application Data
(63) Continuation-in-part of application No. 18/114,175, filed on Feb. 24, 2023.
(63) Continuation-in-part of application No. PCT/US2023/034712, filed on Oct. 9, 2023.

(51) Int. Cl. C10J 3/00; C01B 3/12; C01B 3/56

(52) U.S. Cl. CPC C10J 3/007; C01B 3/12; C01B 3/56; C01B 2203/0405; C01B 2203/043; C01B 2203/0475; C01B 2203/0833; C10J 2200/158; C10J 2300/0946; C10J 2300/1253

(57) ABSTRACT

The invention pertains to a system for extracting hydrogen from a chemically organic feedstock, comprising: an organic waste feeder unit, a screw thermo-gasifier comprising a feedstock inlet at the first end configured to supplying the thermo-gasifier with a chemically organic feedstock, an auger configured to conveying the chemically organic feedstock inside a gasification chamber, a thermogas collector, a hot gas injector configured to inject a hot gas in the screw thermo-gasifier configured to heat up the chemically organic feedstock at a temperature comprised between 800° C. and 900°° C., a high temperature reformer, the high temperature reformer exposing the thermogas to a temperature comprised between 1,200° C. and 1,400°° C. and releasing a reformed gas at a high temperature through a reformed gas outlet, an installation configured to separate hydrogen from the reformed gas, wherein the first duct line comprises an expansion reactor between the thermogas collector and the thermogas inlet.

### CROSS-REFERENCE TO RELATED APPLICATIONS

This application is a continuation in part of US application U.S. Ser. No. 18/114,175 filed on Feb. 24, 2023 and of international application PCT/US2023/034712 filed on Oct. 9, 2023 the latter claiming priority of the former, both claiming priority of U.S. provisional application 63/414,403 filed on Oct. 7, 2022, the contents of all of them are hereby included by reference in their entirety.

### BACKGROUND OF THE INVENTION

The invention pertains to the field of gasification, more specifically, the invention pertains to the production of syngas and hydrogen by the pyrolysis of waste like municipal solid waste comprising or not a biomass.

In all the text, hydrogen means di-hydrogen (H₂) unless specified differently.

Unless specified differently, the term “organic” when associated to a matter or a product shall be construed as related to organic chemistry in a broad sense, i.e., to a product or a matter comprising compounds containing carbon in covalent bonding.

Hydrogen may be used as an energy vector e.g. in a fuel cell to make electricity and to power a motor of an electrical vehicle or any electrical appliance without emitting greenhouse gas (GHG) such as CO₂.

However, at the date of filing of the instant patent application, 96% of hydrogen is made by reforming natural gas, a fossil fuel, without carbon capture, leading to the emission, in the atmosphere, of about 9 times the weight of the produced hydrogen in the form of GHG.

So-called green hydrogen may be produced by the electrolysis of water. However, the yield is very low, about 35%, when comparing the electrical energy used to perform the electrolysis to the electricity released by the fuel cell and becomes even less effective considering the energy required for compression if the hydrogen has to be moved and compressed to e.g. 700 bars (10,290 Psi).

Biomass gasifiers are also used to extract hydrogen from various forms of biomass such as sewage sludge.

According to such a method, a pyrolysis gas is produced by pyrolyzing a biomass and it is further reformed to make a syngas, a gaseous mixture of CO, H2O, CO2, CH4 and H2, from which hydrogen may be selectively extracted, for instance by a Pressure Swing Absorption (PSA) method.

Gasification can be thought as a partial combustion process wherein steam is brought to react with carbon contained in a solid carbonaceous fuel or feedstock.

This reaction occurs at a high temperature, e.g. in a 800° C. to 1,000° C. (1,472° F. to 1,832° F.) range. It is an endothermic reaction, meaning that heat is consumed by the reaction and a source of heat is required to sustain it.

In a conventional gasifier, such heat is, for instance, generated by the combustion of a fraction of the feedstock by providing just enough air or pure oxygen to achieve the desired gasification temperature, in order to sustain the gasification reaction. This is referred to as Partial Oxidation process.

A Although the combustion of biomass emits GHG, these GHGs are not fossils and are recaptured from atmosphere by some biomass, somewhere, in an overall a short cycle. Yet such combustion actually burns fuel/feedstock and consequently a trade-off has to be found between the desired gasification temperature and the amount of feedstock that is consumed to generate the required heat. Thus, Partial Oxidation “consumes” part of the feedstock and, as such, reduces the potential for hydrogen production from that feedstock.

According to another embodiment of the prior art, the feedstock is heated through a heat carrier like a solid medium such as sand or ceramic beads.

Such a method is for instance disclosed in document WO 2021/221164. The solid heat carrier is heated in a preheating installation, then brought, while hot, into contact with a feedstock made of a biomass, thus pyrolyzing the feedstock by heat exchange.

A pyrolysis gas reformer partially burns a fraction of the gas generated by the pyrolysis through the supply of oxygen or air. In order to control the combustion and the temperature, the reformer implementing this method comprises 2 valves, a first valve controls a continuous supply of air or oxygen, and a second valve provides an intermittent supply of air or oxygen to the reformer.

Although, such a device is effective in extracting hydrogen from a biomass feedstock, its efficiency in terms of energy consumption, notably because of the energy required to preheat the solid heat carrier, as well as in terms of investment, requiring costly equipment like a system for feeding, collecting and cleaning the char soiled heat carriers, as well as a complex valve system.

Another system of the prior art uses a plasma at about 4,000° C. in temperature to gasify the feedstock. Such a solution, in addition to be investment intensive also requires high maintenance costs because of the reactor internal walls being subjected to fairly high temperatures.

### SUMMARY OF THE INVENTION

A The system exposed hereafter aims at solving the shortcomings of the prior art and, to this end, pertains to a system for extracting hydrogen from a chemically organic feedstock, comprising:
an organic waste feeder unit,
a screw thermo-gasifier comprising:
a first end and a second end,
a feedstock inlet at the first end configured to supplying the thermo-gasifier with a chemically organic feedstock,
an auger configured to conveying the chemically organic feedstock inside a gasification chamber from the first end to a solid residue outlet at the second end,
a thermogas collector,
a hot gas injector configured to inject a hot gas in the screw thermo-gasifier configured to heat up the chemically organic feedstock at a gasification temperature comprised between 800° C. and 900° C.,
a first duct line configured to convey the thermogas from the thermogas collector to a thermogas inlet of a high temperature reformer, the high temperature reformer exposing the thermogas to a reforming temperature comprised between 1,200° C. and 1,400° C. and releasing a reformed gas at a high temperature through a reformed gas outlet,
a second duct line conveying the reformed gas to an installation configured to separate hydrogen from the reformed gas, and
a hydrogen storage for storing the hydrogen produced by the installation,
wherein the first duct line comprises an expansion reactor between the thermogas collector and the thermogas inlet, and wherein the feedstock inlet comprises a first airlock.

Thus, the system does not use a solid heat carrier in direct contact with the feedstock nor Partial Oxidation but uses indirect heating through a hat chamber thus avoiding all the installations required for heating, circulating and cleaning the solid heat carriers of the prior art. The auger conveying the organic feedstock in the thermo-gasifier enables a fine control of the flow of organic feedstock through the screw thermo-gasifier, a perfect mixing of the organic feedstock and an improved heat exchange with the walls of the gasification chamber, heated by the heat chamber to a gasification temperature as high as 800° C. and over, thus improving the conversion of the organic feedstock into a gas mixture with little solid residues.

The expansion reactor enables to keep a slight negative pressure inside the screw thermos-gasifier which, combined with the rotary airlock, enables a continuous feeding of the screw thermos-gasifier without the thermogas escaping out of the gasification chamber.

The system may be implemented according to the embodiments and variants disclosed hereafter, to be considered individually or according to any technically operative combination.

The expansion reactor may comprise a reactor steam inlet configured to inject steam in the thermogas inside the expansion reactor.

The expansion reactor may comprise a mixing chamber configured to promote mixing of the thermogas with steam by a turbulent flow through the mixing chamber.

According to some embodiment, the thermos-gasifier may comprise a heat chamber comprised between an enclosure of the gasification chamber and an outside enclosure of the screw thermo-gasifier, further comprising a duct line conveying the reformed gas from the reformed gas outlet to the hot gas injector, wherein the hot gas is the reformed gas released from the high temperature reformer and is injected in the heat chamber.

According to some other embodiment, the system may comprise a duct line conveying hydrogen from the hydrogen separation installation to the hot gas injector, the hot gas injector comprising a first oxy-fuel burner wherein the hydrogen is mixed with oxygen by the hot gas injector to produce a high temperature flame configured to raise and maintain a temperature comprised between 800° C. and 900° C. in the gasification chamber.

The screw thermo-gasifier may comprise 2 parallel augers spinning and conveying the organic feedstock in opposite directions from the first end to the second end respectively in a first gasification chamber and in a second gasification chamber, the screw thermo-gasifier further comprising a connection channel between the first gasification chamber and the second gasification chamber.

The high temperature reformer may comprise a second oxy-fuel burner supplied with oxygen and hydrogen from the hydrogen separation installation, configured to produce a high temperature flame adapted to raise the temperature inside the high temperature reformer.

The reformed gas may be cooled in a gas conditioning unit before entering the installation configured to separate hydrogen from the reformed gas, and such a cooling is performed through a heat exchanger exchanging heat with water, wherein the water flowing through the heat exchanger exchanges heat with the reformed gas to make steam.

The steam made at the heat exchanger may be injected into the gasification chamber and into the expansion reactor.

In the installation configured to separate hydrogen form the reformed gas, the reformed gas may be directed to a CO conversion Water Gas Shift Reactor to make a WGSR processed gas, and the steam made at the heat exchanger may be injected into the WGSR.

The WGSR processed gas may be directed to a Pressure Swing Absorption CO₂ separator, before entering a Pressure Swing Absorption device.

The WGSR processed gas may be directed to a membrane reactor for hydrogen separation and the WGSR processed gas may be heated through heat exchange with reformed gas issued from the high temperature reformer before entering a membrane reactor.

The installation adapted to separate hydrogen from the reformed gas may comprise a carbon capture and sequestration unit comprising a mineralization of carbon dioxide in a brine solution and may comprise a production of carbonates (CO₃⁻²).

### BRIEF DESCRIPTION OF DRAWINGS

The system is described hereafter according to some embodiments, in no way limiting, and with reference to FIG. 1 to FIG. 6 wherein:

FIG. 1 is a diagrammatic representation of the system of the invention,

FIG. 2 shows a diagrammatic representation of a gas conditioning unit between the thermolyzing-reforming unit and the hydrogen separation unit,

FIG. 3A is a simplified view in longitudinal cross section of some embodiment of a screw thermo-gasifier,

FIG. 3B shows in a simplified longitudinal cross section view of some other embodiment of a screw thermos-gasifier,

FIG. 3C is a simplified view in longitudinal cross section of an embodiment of the expansion,

FIG. 4 shows according to a simplified view in longitudinal cross section, an exemplary embodiment of the high temperature reformer,

FIG. 5 is a scheme of the hydrogen separation unit, an

FIG. 6 shows a variant of the installation of FIG. 5 wherein the hydrogen separation is performed by a membrane reactor.

### DETAILED DESCRIPTION OF THE INVENTION

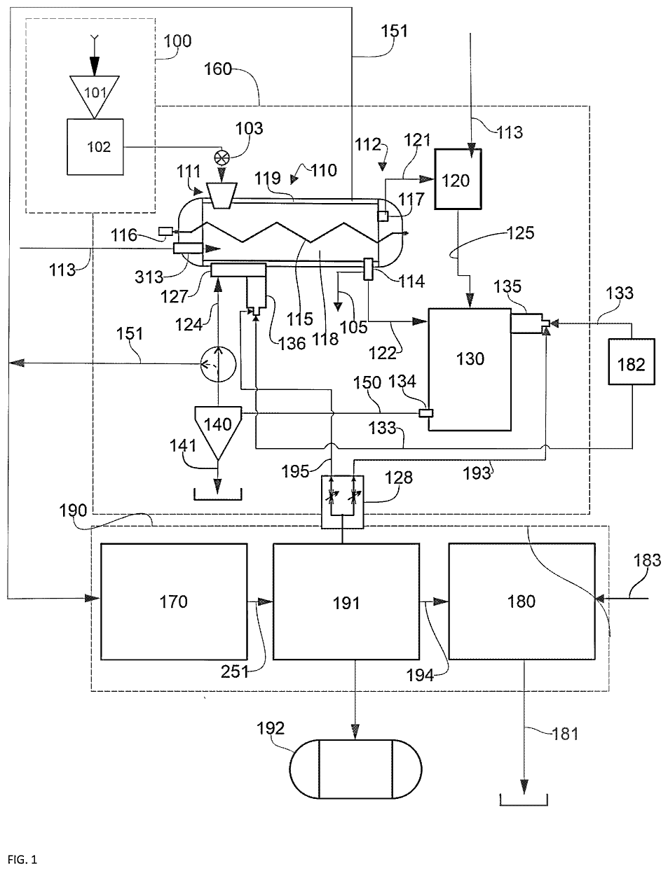

FIG. 1 according to some embodiment, the system comprises an organic waste feeder unit (100) comprising a hopper (102) and a hopper loader (101) for loading a chemically organic feedstock into the system.

The chemically organic feedstock may consist of discarded materials or waste made of organic compounds comprising fixed carbon. The system is very flexible and accepts feedstock further comprising an ash content preferably kept below 5%, although it may accept an ash content reaching up to 30%. The moisture content of the feedstock may range from 5% to 30% but should preferably be around 15%.

The chemically organic feedstock may comprise a plant-based biomass, for example, wooden chips, wooded sawdust, construction waste wood, pruned branches, forest residues, unused trees, agricultural crops residues such as discarded vegetables and fruits, rice straw, wheat straw, rice husk, marine plants, algae, fishery residues, biological biomass, for example, livestock waste, sewage sludge, manure, organic municipal solid waste such as garbage comprising cardboard, plastics and food waste, and any combination thereof.

A preparation of the feedstock may be performed whether on site or in a remote waste collecting plant, or both, notably but not exclusively to adjust ash and moisture content.

When the feedstock contains municipal waste, it may be sorted in order to sort out nonorganic material such as metal, glass or cement from it, the feedstock may then be shredded after sorting. The moisture content may be adjusted by mixing feedstocks of different origins, such as a low moisture content feedstock with a high moisture content feedstock.

This preparation enables to keep the ash and the moisture content of the feedstock in acceptable ranges for the performance of the system.

The chemically organic feedstock is fed into a gasification and reforming installation (160), first into a screw thermo-gasifier (110) through a feedstock inlet comprising a first rotary air lock (103). The first rotary airlock (103), combined with a slight negative pressure inside the screw thermos-gasifier, prevents the thermogas from escaping a gasification chamber (118) of the thermo-gasifier while feeding, thus enabling both discontinuous and/or continuous feeding of the gasification and reforming installation while in use.

According to some diagrammatic embodiment, the screw thermo-gasifier comprises an auger (115) spun inside the gasification chamber (118) by a drive (116) located outside the gasification chamber. The auger drives the organic feedstock from a first end (111) to a second end (112) of the screw thermo-gasifier at a controlled speed defined by the pitch and the spinning speed of the auger.

The screw thermo-gasifier may further comprise a heat chamber (119) separated from the gasification chamber (118) by a wall designed as an internal wall.

A hot-gas injector (127) enables to raise a gasification temperature in the heat chamber (119).

According to some embodiment the hot-gas injector (127) is supplied with high temperature reformed gas through a heating duct line (124) that may circulate inside the heat chamber before being directed to a hydrogen separation installation (190) thus exchanging heat with the gasification chamber.

According to another embodiment the hot-gas injector (127) may comprise a thermo-gasifier oxy-fuel burner (136) supplied with hydrogen coming from the hydrogen separation installation through a hydrogen line (195) and with oxygen supplied by an oxygen line (133), the thermo-gasifier oxy-fuel burner (136) produces a high temperature flame that heats the inside of the gasification chamber.

Whether the gasification chamber (118) is indirectly heated through the heat chamber (119) or directly heated by the combustion of hydrogen or combination thereof, the temperature of the organic feedstock raises as the feedstock conveyed by the auger (115), travels from the first end (111) to the second end (112) of the screw thermo-gasifier (110).

The temperature of the chemically organic feedstock raises from room temperature at the exit of the organic waste feeder unit (100) to 800° C. (1,472° F.) and even up to 900° C. (1,652° F.) in the gasification chamber (118), preferably around 850° C. (1,562° F.).

Actually, the organic feedstock is constantly mixed by the auger (115), thus leading to quick and homogenous heating of the feedstock.

According to some embodiment, the screw thermo-gasifier (110) may comprise a steam injection inlet (313) configured to inject steam from a steam line (113) into the gasification chamber (118), though steam may also be injected in an expansion reactor (120) at the exit of the screw thermo-gasifier.

Steam/water comes from the moisture contained in the organic feedstock, from the steam injected into gasification chamber (118) through the steam injection inlet (313) from a steam line (113) and also from the combustion of hydrogen into the gasification chamber in the embodiment implementing such a feature.

Therefore, the amount of injected steam into the gasification chamber depends on the nature of the organic feedstock, on its moisture content and on the method used to heat up the feedstock into the screw thermo-gasifier.

A thermogas comprising mainly CO, H₂O, CO₂, CH₄ and H₂, as a result of the gasification process, and various other gases in low quantities, exists the screw thermo-gasifier (110) through a thermogas collector (117) and his conveyed by a duct line (121, 125) to a high temperature reformer (130).

A first duct line (121) ducting the thermogas from the screw thermo-gasifier (110) to the high temperature reformer (130) comprises a gas expansion reactor (120) wherein the thermogas is expanded and may be mixed with steam from the steam line (113). The steam enriched thermogas is then conveyed to the high temperature reformer (130) by a second duct line (125).

The gas expansion reactor (120), with its inherent volume, provides an additional means to keep a stable negative pressure within the thermogas pathway, from the thermo-gasifier all the way to the downstream gas separation.

At its second end (112), the screw thermo-gasifier (110) comprises a solid residue outlet (114) where solid residues contained in the organic feedstock, thermolized in the gasification chamber, are collected as ashes and chars. The operating conditions of the screw thermo- gasifier may be set to produce a lower or a higher amount of chars.

In some embodiment, the gasification temperature in the gasification chamber is high enough, i.e., 850° C. or higher, to avoid char formation, thus, only ashes are collected at the solid residue outlet (114). In another embodiment, when char formation is sought, chars are conveyed by a char conveyor (122) to a char inlet of the high temperature reformer (130). Ashes (105) are collected and disposed off-site. Char and ashes may further be used as fertilizers, thus promoting carbon capture by a biomass.

In the high temperature reformer, the thermogas is exposed to a reforming temperature of at least 1,200° C. (2,192° F.) and preferably up to 1,400° C. (2,552° F.).

Such a high temperature is reached by the heat provided by a reformer oxy-fuel burner (135). The burner is supplied with oxygen from an oxygen line (133) and with hydrogen released at the hydrogen separation installation (190). The oxygen line (133) is fed through an oxygen producing device (182), producing oxygen from air e.g. by cryogenic separation.

A distributor (128) enables to adjust the amount of supply in H₂ between the thermo-gasifier oxy-fuel burner (136) and the reformer oxy-fuel burner (135).

During the combustion in the reformer oxy-fuel burner (135) there is no contact with air, thus reducing or even avoiding NOx emissions. The combustion of hydrogen is clean producing mainly steam that further promotes downstream recovery of hydrogen while avoiding increase of unwanted carbon compounds in the reformed gas.

The high temperature reformer (130) produces a gas called a reformed gas, rich in free H₂ and at high temperature.

The reformed gas (150) at high temperature leaves the high temperature reformer (130) through a reform gas outlet (134) and ducted reformed gas (151) is directed toward the hydrogen separation installation (190).

Most of the ashes are removed from the thermogas in the screw thermo-gasifier stage and by a particle filter at the exit of the thermo-gasifier. However, in a specific embodiment the reformed gas may go through an additional particle separator (140) before being directed to the heat chamber (119) of the screw thermo-gasifier.

According to this specific embodiment, ashes (141) separated from the reformed gas are retrieved and disposed.

The following reactions occur in the gasification reforming installation:
partial oxidation of char carbon with oxygen available from the organic feedstock:
C+)₂→CO₂
steam gasification: C+H₂O→ CO+H₂
Methanation: C+2H₂→CH₄
Boudouard reactions: C+CO₂→2CO
Water-gas shift reactions: CO+H₂O→CO₂+H₂
Methane reforming reactions: CH₄+H₂O→CO+3H₂
Acid formation: H₂+Cl₂→2HCl and H₂+S→H₂S

The reformed gas is directed to a reformed gas conditioning unit (170) before entering the hydrogen separation installation.

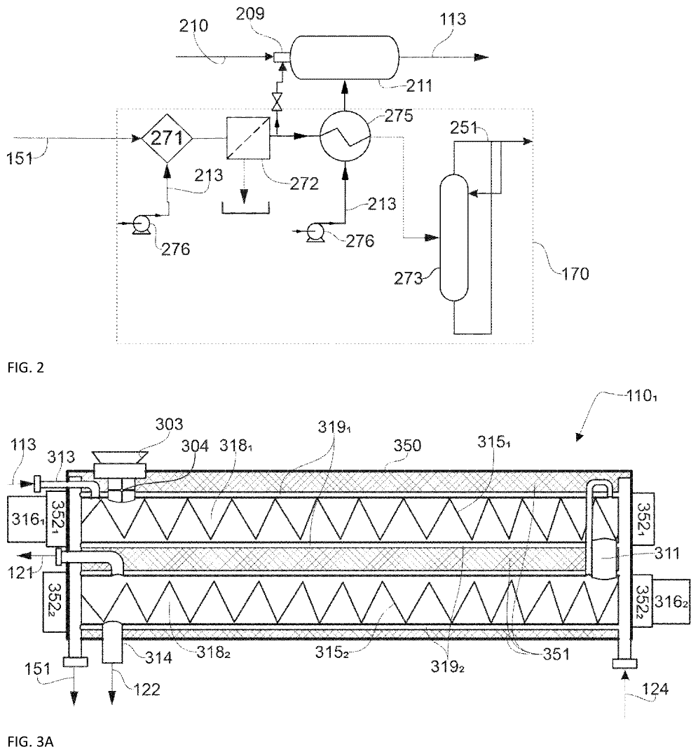

Before entering the hydrogen separation installation, the reformed gas is preferably cooled and further treated for contaminants as shown in FIG. 2 to give a conditioned reformed gas.

According to a specific embodiment, part of the high temperature reformed gas may be conveyed to the hot-gas injector (127) for circulation into the heat chamber (119) of the screw thermo-gasifier by a heating duct line (124). Therefore, the heat of the reformed gas may be used to raise the gasification temperature of the feedstock, this circulation, in such an embodiment, also cools the high temperature reformed gas before entering the reformed gas conditioning unit (170).

The hydrogen separation from the conditioned reformed gas may be performed through a hydrogen separation unit (191) comprising a Pressure Swing Absorption (PSA) device associated with a carbon capture and sequestration unit (180).

The person skilled in the art understands that using a PSA unit for separating hydrogen from the reformed gas is just an exemplary embodiment and that other methods of separation may be contemplated such as membrane separation or cryogenic separation without changing the principle of the system.

The reformed gas shall be cleaned and cooled before entering the hydrogen separation unit.

The hydrogen produced by the hydrogen separation unit, is stored in a storage (192), for instance in a pressurized tank with a pressure comprised between 300 bars and 700 bars (4410 PSI to 10290 PSI), so as to reduce the storage volume, or, according to variants, may also be liquefied, or stored in a dry adsorption media such as metal hydrides.

The carbon capture and sequestration unit (180) processes carbon dioxide and stores carbon in carbonates (181).

The carbon capture and sequestration unit (180) may be of the kind distributed by CAPTICO2® a company set in Norway, Solheimsgaten 16, 5058 Bergen, wherein the carbon dioxide is mineralized in a brine solution (183) Ca (OH)₂. After drying it can be disposed, e.g. buried, or sold for specific uses.

FIG. 2 the ducted reformed gas (151) is brought to the gas conditioning unit (170) by a third duct line and is first directed to a quenching unit (271) supplied with water (213) in order to lower its temperature.

According to an embodiment the reformed gas goes through a scrubber (273) and a fine particulate filter (272).

The scrubbing allows to clean the gas from hydrogen chloride, hydrogen sulfide and other corrosive elements.

The fine particulate filter (272) allows the removal of very fine ashes from the reformed gas which are collected and disposed.

The reformed gas may be further cooled before entering the scrubber. To this end, before entering the scrubber, the reformed gas may be cooled by passing through a heat exchanger (275) supplied with a stream of water (213). In the heat exchanger the water turns to steam that is further supplied to the steam consuming devices of the installation, such as in the reformer, the expansion reactor and the screw thermo-gasifier through the steam line (113).

At the start up of the installation the flow of reformed gas may not be high enough to produce enough steam through the heat exchanger (275). To this end the installation further comprises a boiler (211) comprising a boiler burner (209).

The boiler burner (209) may be supplied with reformed gas or with a LPG through a LPG line (210), the latter configuration being used only for the starting up of the installation, or may also be supplied with hydrogen and oxygen.

From the thermo-gasifier and gas reforming stages (160) to the entry in the reformed gas conditioning unit (170) the installation performs under a slightly negative pressure comprised between −30 mmwc and 0, preferably between −30 mmwc and −10 mmwc (millimeters of water column) relative to the atmospheric pressure, At the exit of the fine particulate filter (272) and before entering the hydrogen separation unit the pressure of the conditioned reformed gas is increased by a compressor (276) to a pressure comprised between 10 bars and 20 bars (147 PSI to 294 PSI) preferably about 15 bars (220 PSI).

The reformed gas conditioning unit (170) releases a conditioned reformed gas (251) that is directed to the hydrogen separation unit.

According to some embodiment (not shown) the whole system may be comprised, ready for assembly, in a plurality of 20 feet ISO containers, that may be superimposed and connected.

All the components are positioned and fixed in each container, said container have sufficient rigidity to support all the components and their own weight.

Therefore, installing the system consists mainly in connecting the piping and the containers, the containers making the structural frame of the installation, they can lay on site on a concrete slab or on a steel rafter.

For this purpose, the components are designed as compact as possible.

According to some embodiment the screw thermo-gasification unit is comprised in a container. The reforming unit may be comprised in the same container next to thermos- gasification unit, or in another container for instance underneath in the container comprising the thermos-gasification unit.

According to such an embodiment the screw thermo-gasifier (1101, 1102) is basically of a tubular shape, set horizontally, comprising a first end and a second end, and means to convey a feedstock introduced at the first end towards the second end.

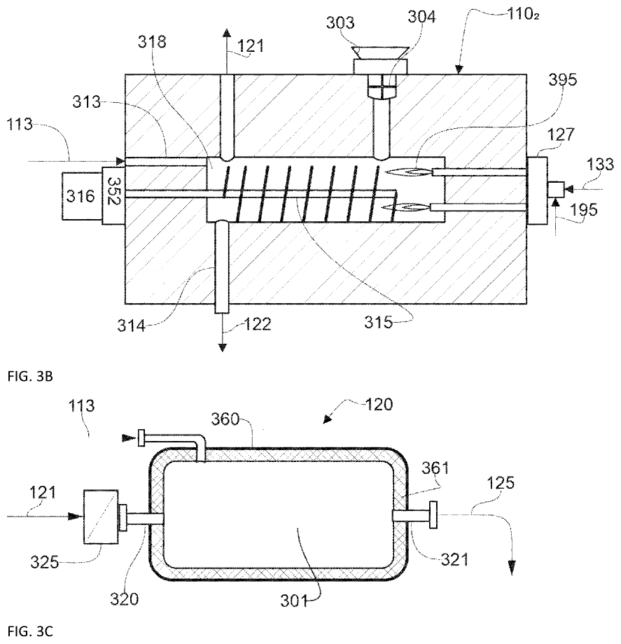

FIG. 3A, according to some embodiment, the screw thermo-gasifier (1101) may comprise a first auger (3151) and a second auger (3152) parallel to the first, as means for conveying the feedstock, each auger being comprised between two bearings (3511, 3512) the augers being driven by 2 electric drives (3161, 3162). The screw thermo-gasifier (110) offers the advantage over a rotary kiln, that the bearings and the corresponding sealings are outside the high gasification temperature zone, that the bearings can be cooled without any effect on the operation of the device, therefore reducing costs also avoiding the use of lip seals which could leak thermogas to the atmosphere.

The two augers (3151, 3152) may drive the feedstock in opposite directions over a total travel length that is roughly double the overall length of the screw thermo-gasifier (1101), therefore making it more compact.

Each of the augers (3151, 3152) may have a single or multiple thread with a constant or a variable pitch over its length, the two augers may have different pitches and different pitch variation, one auger or both of them may be conical.

Each auger spins inside a first gasification chamber (3181) and in a second gasification chamber (3182) the two gasification chambers being connected together through a connection channel (322), so that the feedstock is fed in the screw thermo-gasifier (1101) by a feeding hopper (303) in the first gasification chamber at a first end, the feeding end, is then driven toward an opposite end of the first gasification chamber (3181) by the first auger (3151), when it falls into the second gasification chamber (3182) through the connection channel (311) in a first end of the second gasification chamber (3182), and is then driven to an opposite end of the second gasification chamber, the collecting end, by the second auger (3152).

The feeding hopper at the thermo-gasifier feedstock inlet may comprise a second rotary airlock (304).

The latter rotary airlock (304) may be used alone or concurrently with the first rotary airlock (103) upstream the feeding hopper, in order to provide continuous feeding of the installation while avoiding the thermogas to escape through the feeding port, and also avoiding uncontrolled introduction of air in the gasification chambers. To this end the feeding hopper (303) may comprise one or more sensors (3030) like a loadcell or a load level sensor in order to control the feedstock fed during operation.

In some embodiment the gasification chambers may be cylindrical with a circular cross section, yet the cross section of the gasification chambers may be e.g. elliptical and one or both the gasification chambers may extend over a conical shape in order to cooperate with the shape, sections, threads, pitches and pitch variations of the augers. As an exemplary implementation, the walls of the gasification chambers are heated by sets of tubular ducts (3191, 3192) set around each gasification chamber and conveying a high temperature reformed gas.

The tubular ducts as well as the walls of the gasification chamber are, for instance, made of ceramics, like aluminum nitride, or made of a high temperature resistant nickel-based alloy coated with a thigh thermal conductivity ceramic such as aluminum nitride, beryllium oxide, silicon carbide or silicon nitride, to resisting abrasion and withstanding the high temperatures.

The screw thermo-gasifier comprises an external (350) enclosure and thermal insulation layers (351) between the gasification chambers and this enclosure as well as between the gasification chambers.

According to another embodiment the heating chamber consists of a jacketed space between an inner gasification chamber wall and an outer enclosure wall, the high temperature reformed gas circulating directly in this jacketed space without tubular ducts conveyance.

FIG. 3B according to some other embodiment the screw thermos-gasifier (1102) may comprise a direct heating into the gasification chamber. The screw thermos-gasifier (1102) is here shown with a single auger, the person skilled in the art understands that it may comprise 2 augers as in the embodiment shown in FIG. 3A.

The auger (315) may be driven by an electric drive (316) and guided on bearings (352) both the electric drive and the bearing being set outside of the high temperature area as in the previous embodiment.

In the same way, the screw thermo-gasifier may also comprise a heat chamber operating in combination with the direct heating in the gasification chamber.

In this embodiment hydrogen is brought to the hot-gas injector (127) through a hydrogen line (195) coming for the hydrogen separation installation, the hot gas injector comprises for instance an oxy-fuel burner supplied in oxygen through an oxygen line (133) so as to produce a high temperature flame (395) in the gasification chamber (318) by the combustion of hydrogen and oxygen, thus raising and maintaining the gasification temperature in a range of 800° C. to 900° C. in the gasification chamber.

The combustion of hydrogen is clean and because the entry of air is limited in the gasification chamber thanks to the airlocks, the production of NOx is very limited.

The screw thermo-gasifier as well as the whole thermolyzing-reforming unit works under atmospheric pressure or under a light negative pressure, therefore, they do not require oversized thicknesses to withstand high pressures.

Whatever the embodiment a steam inlet (313) enables to inject steam from the steam line (113) into the gasification chamber (318, 3181), if needed depending on the moisture content of the feedstock.

As the feedstock, driven by the augers (315, 3151, 3152), travels from the feeding end to the disposal end, the organic feedstock, mixed with steam if applicable, gasifies according to the chemical reactions given above and, on one hand, turns to a solid residue, i.e. char and ashes, collected at the collecting end through one or more solid residues outlets (314), and on another hand, to a gas, called a thermogas which is basically a syngas, collected by a thermogas outlet (321).

The system operating conditions avoid char production. However, if such optimal conditions cannot be reached, e.g. because of the nature of the feedstock or at the starting up of the system, it may produce a low quantity of chars which are collected at the solid residues outlet (314).

Unless set for this purpose, the installation does not produce chars in steady state operating conditions. Yet in some embodiment the selection of feedstock and the operation of the installation my be set to produce some char, the chars may be further directed to the high temperature reformer by a char conveyor. Ashes are disposed off-site. Alternatively, chars may also be disposed off-site.

The thermogas is collected from the gasification chambers (315, 3151, 3152) through a pipe work and directed to an expansion reactor (120) where it is mixed with steam before being conveyed to the high temperature reformer.

The screw thermo-gasifier being set horizontally, thermogas is collected on top of the screw thermo-gasifier while solid residues are collected on the bottom of the thermo-gasifier, the feedstock traveling along a horizontal axis.

FIG. 3C the expansion reactor (120) is preferably located beside and attached to the screw thermo-gasifier making therefore a compact installation.

The expansion reactor comprises an external shell (360) with a thermal insulation (361), the inner wall being made of ceramic or coated with ceramic.

The thermogas leaving the screw thermo-gasifier (1101, 1102) enters the expansion reactor (120) preferably through a particle filter (325) at a thermogas inlet (320).

The expansion reactor enables to keep the pressure in the overall installation up to a CO2 separation stage, to a level close to the atmospheric pressure and preferably to a slightly negative pressure, typically in a range of −10 mmwc to −30 mmwc and allows to inject steam into the thermogas released by the thermo-gasifier. Steam is injected from the steam line (113) through a Venturi effect.

The expansion reactor (120) comprises a mixing chamber (301) wherein the injection of steam promotes turbulences in the thermogas stream and enhances the mixing of steam and thermogas as well as reactions. The steam also provides an additional hydrogen source to the thermogas while the expansion reactor provides the residence time and space for the gaseous reactions to take place.

The thermogas escapes the expansion reactor by a thermogas outlet (321) and is directed to the high temperature reformer.

When the system is set in stacked containers, the container comprising the high temperature reformer is set underneath the container comprising the screw thermo-gasifier and the expansion reactor.

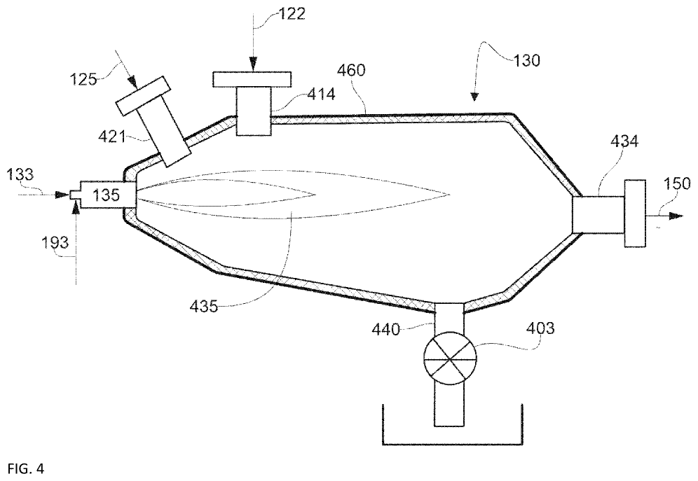

FIG. 4 According to some exemplary embodiment, the high temperature reformer (130) is set horizontally and comprises an external shell (460), an insulation layer (461) and a ceramic internal lining. Steam-enriched thermogas issued from the expansion reactor enters the high temperature reformer at one end through a thermogas inlet (421) and chars, when present, may be conveyed by a char conveyor (122) to a char inlet (414). The steam-enriched thermogas entering the high temperature reformer through the second duct line (125) is enriched in steam through the steam injection performed in the expansion reactor.

The reformer oxy-fuel burner (135) is supplied with the off-gas produced either as a byproduct of the hydrogen separation installation through a dedicated pipeline (193), the off-gas comprising H₂ and CO, or, according to a preferred embodiment, by a portion of H₂ produced by the hydrogen separation unit that is collected and ducted accordingly. The oxy-fuel burner is supplied with industrial grade oxygen; therefore, the combustion does not involve air and the potential creation of NOx.

The combustion makes a high temperature flame (435) inside the reformer, raising the temperature therein up to 1,200° C. and even up to 1,400° C.

The reformed gas (150) leaves the high temperature reformer through a reformed gas outlet (434) and solid residues are collected at the bottom of the reformer through an ash hatch (440) comprising a rotary valve airlock (403). The ashes are further disposed off-site.

As shown above, reformed gas (150) at high temperature is directed to a particle cleaning station before being conditioned and send to the hydrogen separation unit, and for one part of it, may first go through the heat chamber of the screw thermo-gasifier, depending on the embodiment of the latter, before going through the reformed gas conditioning unit.

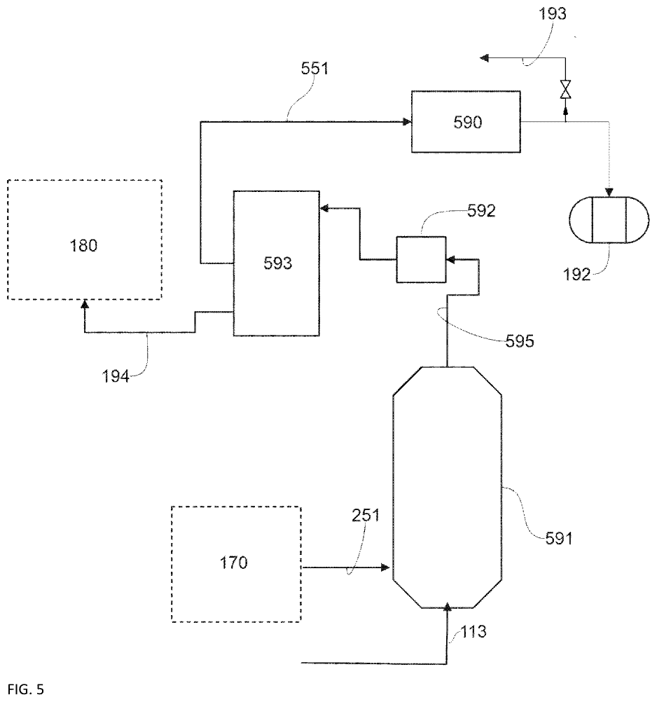

FIG. 5 the conditioned reformed gas (251) rich in H₂ exiting de reformed gas conditioning unit (170), but comprising also CO, CO₂ and N₂, may first enter a CO conversion Water Gas Shift Reactor (591, WGSR).

The WGSR contains catalyzing media and uses steam injected from the steam line (113) to cause the carbon monoxide in the reformed gas to react and to form hydrogen and carbon dioxide. The WGSR (591) removes 100% of the carbon monoxide and significantly increases the hydrogen content in the reformed gas. The WGSR operates at a positive pressure typically about 15 bars (220 PSI).

Exiting the WGSR (591) the WGSR processed gas (595) comprising CO₂, H₂ and N₂ is filtered through a filtering and compression unit (592) comprising an ultrafine filter and a screw compressor adapted to compress the reformed gas to a pressure of 20 to 30 bars (294 PSI to 440 PSI) before entering a Pressure Swing Absorption CO₂ separator (593).

The PSA separates 100% of the carbon dioxide leaving only hydrogen and nitrogen in the PSA processed gas (551) that enters the Pressure Swing Absorption device (590) that separates H₂.

The CO₂ (194) is directed to a carbon capture and sequestration unit (180) where carbon is processed and stored as a solid medium and other gasses, comprising mostly hydrogen may be used to supply the oxy-fuel burners.

The PSA device (590) produces hydrogen with a purity which meets ISO 14687 Grade D specs for use in PEM Fuel Cells.

The hydrogen is stored in a storage (192) for instance in a pressure tank, while part of it is collected and sent through dedicated pipelines (193, 195) to supply the oxy-fuel burners (135 136) of the high temperature reformer and of the screw thermos-gasifier depending on the embodiment of the later.

Therefore, considering the system as a whole, the only gaseous air discharge consists of steam and nitrogen.

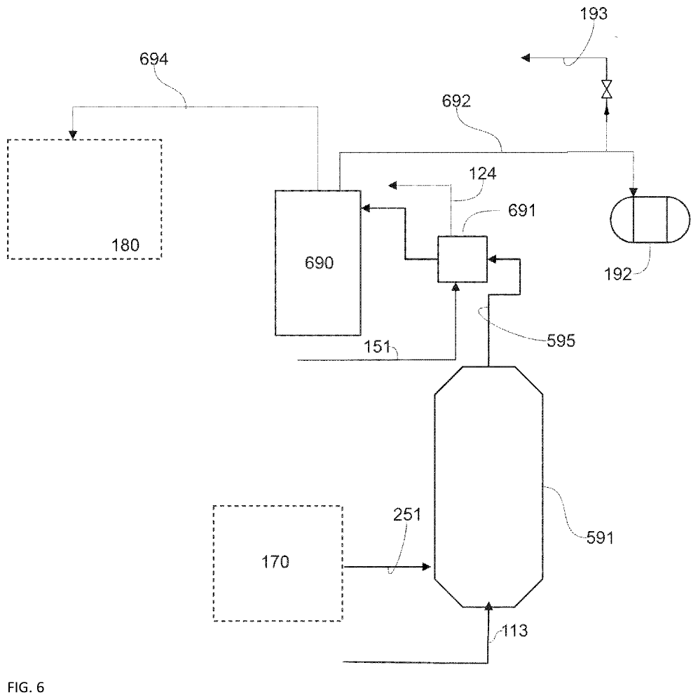

FIG. 6 according to an alternate embodiment the hydrogen separation is performed through a membrane reactor (690) for instance through a palladium membrane reactor.

According to this embodiment the WGSR processed gas (595), is directed first through a heat exchanger (691) where it is heated to a temperature high enough to react in the membrane reactor (690).

According to an exemplary embodiment the heating is provided through heat exchange with ducted reformed gas (151) coming from the high temperature reformer, this gas may also be further directed to the heating duct line (124) to heat up the heating chamber of the screw thermo-gasifier, depending on the embodiment of the latter.

The membrane reactor (690) separates the WGSR processed gas (595) into a CO₂ rich stream (694) that is directed to the carbon capture and sequestration unit and to Fuel Cell grade H₂ (692) that is directed to a storage (192), part of it, may be directed to dedicated pipelines (193, 195) to be used for supplying the oxy-fuel burners (135, 136).

The latter embodiment is less investment intensive than the embodiment depicted in FIG. 5 and also allows a production increase of H₂ by 50%.

As shown above, whatever the embodiment the pressure of the gases in the installation increases gradually from atmospheric pressure to the hydrogen separation and finally the storage. Consequently, the gas does not go through energy consuming compression and expansion cycles.

### EXAMPLES

### Example 1

The following table shows a nonlimiting examples of the material flows through the installation according to a first embodiment wherein the high temperature reformer oxy-fuel burner is supplied with an off-gas comprising mostly CO and H₂.

Although the system may transform a mix of chemically organic feedstock like municipal waste, the feedstock considered in this example is wooden chips.

Once a steady state is reached the system produces about 39 kg of hydrogen per hour, thus a potential energy of 1.3 MWh per hour, while being self-sustainable.

Part of this produced hydrogen may be used in a fuel cell to produce the electricity required for the system, e.g. for the drives of the screw thermo-gasifier.

TABLE 1

| Material | Flow rate | | Material | Flow rate |
|---|---|---|---|---|
| input | [Kg/hour] | Stage | output | [Kg/hour] |
| Organic | 421 | Thermnolyzer | Thermogas | 517.26 |
| feedstock | | (110) | (121) | |
| Steam | 155.87 | | Ash (105)/chars | 61.30 |
| | | | (122) | |
| Thermogas | 517.26 | High | Raw reformed | 718.81 |
| (121) | | temperature | gas (150) | |
| | | reformer (130) | | |
| Ash/Char | 61.30 | | Ash/Char | 61.30 |
| Steam | 98.82 | | | |
| Off-gas (193) | 11.64 | | | |
| Oxygen (133) | 92.62 | | | |
| Clean Reformed | 718.81 | Gas | Conditioned | 564.71 |
| gas (151) | | conditioning | reformed gas | |
| | | unit (170) | (251) | |
| Process water | 150 | | steam (113) | 527.35 |
| | | | blowdown | 32 |
| | | | Salts/acid | 48 |
| Conditioned | 564.71 | Carbon capture | Conditioned | 409.59 |
| Reformed gas | | | Reformed gas | |
| (251) | | | Captured Co2 | 155.12 |
| Conditioned | 409.59 | Hydrogen | Off-gas (193) | 353.88 |
| Reformed gas | | separation (190) | Pure H2 | 38.58 |
| (251) | | | impurities | 17.13 |

### Example 2

In this second example the high temperature reformer oxy-fuel burner is supplied with H₂ issued from the Pressure Swing Absorption device.

The feedstock is wooden chips the major constituents of which, with regard to the process, are given in Table 2.

TABLE 2

| Constituents | Weight % | Kg/h |
|---|---|---|
| Carbon | 46.00% | 506.00 |
| Hydrogen | 6.00% | 66.00 |
| Chlorine | 0.50% | 5.50 |
| Oxygen | 25.00% | 275.00 |
| Nitrogen | 1.00% | 11.00 |
| Sulfur | 0.50% | 5.50 |
| H2O | 6.44% | 70.84 |
| Metal | 0.00% | 0.00 |
| Inorganics/ashes | 14.56% | 160.16 |
| Totals | 100.00% | 1,100.00 |

Steam is injected at a pressure of 10 Bar gauge and a temperature of 175° C. in the steam line (113) for supplying the devices using steam, e.g. the screw thermo-gazifier, the expansion reactor (120), the high temperature reformer (130) and the WGSR (591).

Table 3 gives the main streams between the different stations of the installation.

TABLE 3

| MATERIAL | Flow rate | | | Flow rate |
|---|---|---|---|---|
| INPUT | (Kg/hr) | Stage | Material Output | (Kg/hr) |
| Organic | 1100.00 | Thermo- | Thermogas (121) | 1347.04 |
| Feedstock | | gasifier | Ashes | |
| Steam (113) | 407.26 | (110) | (105)/Char | 160.16 |
| | | | (122) | |
| Thermogas (121) | 1347.04 | High | Reformed Gas | 1827.10 |
| | | | (150) | |
| Steam (113) | 18.49 | Temperature | | |
| Off-Gas/Pure | 51.47 | Reformer | | |
| Hydrogen (193) | | | | |
| Oxygen (133) | 409.74 | (130) | | |
| Reformed Gas | 1827.10 | Gas | Conditioned | 1473.88 |
| (151) | | Conditioning | Reformed Gas | |
| | | | (251) | |
| Process Water | 475.00 | Unit (170) | Steam (113) | 1118.46 |
| Demineralized | 1174.38 | | Blowdown + | 397.89 |
| Water | | | Condensate | |
| | | | Waste water | 475.00 |
| | | | Salts/Acid | 25.57 |
| Conditioned | 1473.88 | Water-Gas | WGSR Processed | 2037.72 |
| Reformed Gas | | Shift Reactor | Gas (595) | |
| (251) | | | | |
| Steam (113) | 563.53 | (591) | | |
| WGSR Processed | 2037.72 | PSA CO₂ | PSA Processed | 254.49 |
| Gas (595) | | separator | Gas (551) | |
| | | (593) | | |
| | | | Captured | 1782.83 |
| | | | CO₂ (194) | |
| PSA Processed | 254.49 | Hydrogen | Off-Gas to | 60.03 |
| Gas (551) | | | Ox-Fuel | |
| | | | Burner (193) | |
| | | Separation | Fuel-Cell Grade | 142.95 |
| | | | Hydrogen (692) | |
| | | (190) | Pure Hydrogen to | 51.50 |
| | | | Oxy-Fuel Burner | |
| | | | (193) | |
| Captured CO₂ | 1782.83 | carbon | CaCO₃ (181) | 4051.89 |
| (194) | | capture and | | |
| Brine solution | 2998.40 | sequestration | H₂O | 729.34 |
| Ca(OH)₂ (183) | | (180) | | |

As a whole, in such a configuration, the system produces 69 Kg/h of ISO 14687 Grade D hydrogen along with 102 Kg/h of hydrogen mixed with traces of CO2 and N2 that can be either used for burning in the oxyfuel burners, or directed to a second PSA device to further extract fuel cell grade H2.

According to the above example 22.48 Kg/h of PSA quality H2 is used to supply the oxy-fuel burner.

The thermogas composition is given in Table 4.

TABLE 4

| Constituents | Weight % | Mol %/Vol % |
|---|---|---|
| Carbon Monoxide | 37.71% | 21.75% |
| (CO) | | |
| Carbon Dioxide (CO₂) | 30.09% | 11.04% |
| Hydrogen (H₂) | 6.31% | 50.72% |
| Tar | 10.55% | 2.84% |
| Nitrogen (N₂) | 0.82% | 0.47% |
| Hydrochloric Acid | 0.42% | 0.19% |
| (HCl) | | |
| Hydrogen Sulphide | 0.44% | 0.21% |
| (H₂S) | | |
| H₂O | 8.94% | 8.02% |
| Methane (CH₄) | 4.71% | 4.76% |
| TOTAL | 100.00% | 100.00% |

The reformed gas composition at the exit of the high temperature reformer is given in Table 5.

TABLE 5

| Constituents | Weight % | Mol %/Vol % |
|---|---|---|
| Carbon Monoxide | 50.50% | 25.59% |
| (CO) | | |
| Carbon Dioxide (CO₂) | 22.18% | 7.15% |
| Hydrogen (H₂) | 7.36% | 51.94% |
| Tar | 0.00% | 0.00% |
| Nitrogen (N₂) | 0.60% | 0.31% |
| Hydrochloric Acid | 0.31% | 0.12% |
| (HCI) | | |
| Hydrogen Sulphide | 0.32% | 0.13% |
| (H₂S) | | |
| H₂O | 18.72% | 14.75% |
| Methane (CH₄) | 0.00% | 0.00% |
| TOTAL | 100.00% | 100.00% |

The composition of the WGSR processed gas is given in Table 6. Note that the gas entering the WGSR units went prior through the gas conditioning unit (170).

TABLE 6

| Constituents | Weight % | Mol %/Vol % |
|---|---|---|
| Carbon Monoxide | 2.26% | 1.17% |
| (CO) | | |
| Carbon Dioxide (CO₂) | 87.49% | 28.78% |
| Hydrogen (H₂) | 9.68% | 69.75% |
| Tar | 0.00% | 0.00% |
| Nitrogen (N₂) | 0.54% | 0.28% |
| Hydrochloric Acid | 0.00% | 0.00% |
| (HCl) | | |
| Hydrogen Sulphide | 0.00% | 0.00% |
| (H₂S) | | |
| H₂O | 0.02% | 0.01% |
| Methane (CH₄) | 0.00% | 0.00% |
| TOTAL | 100.00% | 100.00% |

The composition of the CO2 VPSA processed gas is given in Table 7.

TABLE 7

| Constituents | Weight % | Mol %/Vol % |
|---|---|---|
| Carbon Monoxide | 18.10% | 1.64% |
| (CO) | | |
| Carbon Dioxide (CO₂) | 0.00% | 0.00% |
| Hydrogen (H₂) | 77.43% | 97.94% |
| Tar | 0.00% | 0.00% |
| Nitrogen (N₂) | 4.32% | 0.39% |
| Hydrochloric Acid | 0.01% | 0.00% |
| (HCl) | | |
| Hydrogen Sulphide | 0.01% | 0.00% |
| (H₂S) | | |
| H₂O | 0.13% | 0.02% |
| Methane (CH₄) | 0.00% | 0.00% |
| TOTAL | 100.00% | 100.00% |

1. A system for extracting hydrogen from a chemically organic feedstock, comprising:
an organic waste feeder unit,
a screw thermo-gasifier comprising:
a first end and a second end,
a feedstock inlet at the first end configured to supplying the thermo-gasifier with a chemically organic feedstock,
an auger configured to conveying the chemically organic feedstock inside a gasification chamber from the first end to a solid residue outlet at the second end,
a thermogas collector,
a hot gas injector configured to inject a hot gas in the screw thermo-gasifier configured to heat up the chemically organic feedstock at a gasification temperature comprised between 800° C. and 900° C. to make a thermogas,
a first duct line configured to convey the thermogas from the thermogas collector to a thermogas inlet of a high temperature reformer, the high temperature reformer exposing the thermogas to a reforming temperature comprised between 1,200° C. and 1,400° C. and releasing a reformed gas at a high temperature through a reformed gas outlet,
a second duct line conveying the reformed gas to hydrogen separation installation configured to separate hydrogen from the reformed gas, and
a hydrogen storage for storing the hydrogen produced by the hydrogen separation installation,
wherein the first duct line comprises an expansion reactor between the thermogas collector and the thermogas inlet, and wherein the feedstock inlet comprises a first airlock.

2. The system of claim 1, wherein the expansion reactor comprises a reactor steam inlet configured to inject steam in the thermogas inside the expansion reactor.

3. The system of claim 2, wherein the expansion reactor comprises a mixing chamber configured to promote mixing of the thermogas with steam by a turbulent flow through the mixing chamber.

4. The system of claim 1, wherein the thermo-gasifier comprises a heat chamber comprised between an enclosure of the gasification chamber and an outside enclosure of the screw thermo-gasifier, further comprising a duct line conveying the reformed gas from the reformed gas outlet to the hot gas injector, wherein the hot gas is the reformed gas released from the high temperature reformer and is injected in the heat chamber.

5. The system of claim 1, comprising a duct line conveying hydrogen from the hydrogen separation installation to the hot gas injector, the hot gas injector comprising a first oxy-fuel burner wherein the hydrogen is mixed with oxygen by the hot gas injector to produce a high temperature flame configured to raise and maintain the gasification temperature comprised between 800° C. and 900° C. in the gasification chamber.

6. The system of claim 1, wherein the screw thermo-gasifier comprises 2 parallel augers spinning and conveying the chemically organic feedstock in opposite directions from the first end to the second end respectively in a first gasification chamber and in a second gasification chamber, the screw thermo-gasifier further comprising a connection channel between the first gasification chamber and the second gasification chamber.

7. The system of claim 1, wherein the high temperature reformer comprises a second oxy-fuel burner supplied with oxygen and hydrogen from the hydrogen separation installation, configured to produce a high temperature flame adapted to raise the temperature inside the high temperature reformer.

8. The system of claim 1, wherein the reformed gas is cooled in a gas conditioning unit before entering the hydrogen separation installation and wherein such a cooling is performed through a heat exchanger exchanging heat with water, wherein the water flowing through the heat exchanger exchanges heat with the reformed gas to make steam.

9. The system of claim 8, wherein the steam made at the heat exchanger is injected into the gasification chamber and into the expansion reactor.

10. The system of claim 8, wherein, in the hydrogen separation installation, the reformed gas is directed to a CO conversion Water Gas Shift Reactor to make a WGSR processed gas, and wherein steam made at the heat exchanger is injected into the WGSR.

11. The system of claim 10, wherein the WGSR processed gas is directed to a Pressure Swing Absorption CO₂ separator, before entering a Pressure Swing Absorption device.

12. The system of claim 10, wherein the WGSR processed gas is directed to a membrane reactor for hydrogen separation and wherein the WGSR processed gas is heated through heat exchange with reformed gas issued from the high temperature reformer before entering a membrane reactor.

13. The system of claim 1, wherein the hydrogen separation installation comprises a carbon capture and sequestration unit comprising a mineralization of carbon dioxide in a brine solution and comprises a production of carbonates (CO₃⁻²).
